(19) United States
(12) Patent Application Publication
(10) Pub. No.: US 2008/0024458 A1
(43) Pub. Date: Jan. 31, 2008

(54) Assignment of Functions to a Softkey

(76) Inventor: Timo Nieminen, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/664,148

(22) PCT Filed: Sep. 30, 2004
(86) PCT No.: PCT/IB04/03183

§ 371 Date: Mar. 29, 2007

(51) Int. Cl. G06F 3/023

(52) U.S. Cl. 345/173

(57) ABSTRACT

The invention relates to a method of controlling an assignment of functions to a softkey 12 of an electronic device 10, wherein at least two different functions are available for an assignment to the softkey 12. The electronic device 10 further comprises touch sensitive means 15, which are adapted to detect a touch of at least one predetermined part of the electronic device 10 and to output signals indicating a detected touch. In order to improve the usability of the softkey, the method comprises selecting 203, 207 a function based on signals from the touch sensitive means 15, and assigning 204, 208 the selected function to the softkey 12. The invention relates equally to a software code realizing this method, to a software program product storing such a code and to a corresponding electronic device 10.

### CROSS REFERENCE TO RELATED APPLICATIONS

This application is the U.S. National Stage of International Application Number PCT/IB04/003183 filed on Sep. 30, 2004 which was published in English on Apr. 6, 2006 under International Publication Number WO 2006/035260.

### FIELD OF THE INVENTION

The invention relates to a method of controlling an assignment of functions to at least one softkey of an electronic device. The invention relates equally to such an electronic device, to a software code for such an electronic device and to a software program product storing such a software code.

### BACKGROUND OF THE INVENTION

It is well known to provide an electronic device with a softkey. A mobile phone, for example, often comprises a normal ITU-T keypad including keys for digits ‘0’ to ‘9’, for pound ‘#’ and for asterisk ‘*’, and in addition a left softkey, a right softkey and a middle softkey. A provided softkey may also be realized in form of a selection key or joystick.

The functions which are assigned to the softkeys are not fixed. They are rather defined by software depending on the current context. The functions which are presently assigned to the left softkey and the right softkey of a mobile phone are usually indicated on a display.

A user may alter the current assignment of functions to the provided softkeys for example by means of a menu structure offered by one of the softkeys. The assignment of functions to the softkeys is thus context dependent and/or control dependent and reflected by the respective visual presentation. Due to the increasing number of features, however, the user interface becomes crowded with the available menu items.

### SUMMARY OF THE INVENTION

It is an object of the invention to improve the usability of softkeys in an electronic device.

A method of controlling an assignment of functions to at least one softkey of an electronic device is proposed. At least two different functions are available for an assignment to the at least one softkey. Further, the electronic device comprises touch sensitive means, which are adapted to detect a touch of at least one predetermined part of the electronic device and to output signals indicating a detected touch. The proposed method comprises selecting a function based on signals from the touch sensitive means. The proposed method further comprises assigning the selected function to the at least one softkey.

Moreover, an electronic device is proposed, which comprises at least one softkey, wherein at least two different functions are available for being assigned to the at least one softkey. The proposed electronic device further comprises touch sensitive means adapted to detect a touch of at least one predetermined part of the electronic device and to output signals indicating a detected touch. The proposed electronic device further comprises a processing component adapted to select a function based on signals output by the touch sensitive means and to assign a selected function to the at least one softkey.

Moreover, a software code for controlling an assignment of functions to at least one softkey of an electronic device is proposed. At least two different functions are available for an assignment to the at least one softkey. Further, the electronic device comprises touch sensitive means, which are adapted to detect a touch of at least one predetermined part of the electronic device and to output signals indicating a detected touch. When running in a processing component of an electronic device, the software code selects a function based on signals received from the touch sensitive means. Further, the software code assigns the selected function to the at least one softkey.

Finally, a software program product is proposed, which stores such a software code.

The invention proceeds from the consideration that the assignment of a desired function to a softkey of an electronic device can be made more flexible by providing an additional assignment approach, which does not rely on a visible menu structure like the conventional assignment approach. It is therefore proposed that a specific function can be assigned to a softkey by a simple touch of a particular part of the electronic device. To this end, touch sensitive means are employed, which provide signals indicative of a detected touch.

It is an advantage of the invention that it increases the efficiency of the electronic device. It allows a faster assignment of functions than by using a conventional options list. The assignment of a function based on a touch constitutes a kind of a short cut.

It is further an advantage of the invention that its application is intuitive to a user. The user may directly manipulate the assigned functions.

It is further an advantage of the invention that it improves the scalability of the device, since it allows providing more commands in the user interface.

As long as the touch sensitive means are not manipulated, the softkeys may have a conventional functionality with a single static function or a context sensitive menu of several functions.

In one embodiment of the invention, an indication of the function which is currently assigned to a softkey is provided to a user via a user interface, for instance in form of a text in a softkey label section of a display. Thereby, a user is always aware of the function which is currently assigned to a softkey.

The touch sensitive means can be realized in various ways. They may comprise for instance, though not exclusively, a capacitive touch sensitive pad, which is known as such. Such a capacitive touch sensitive pad is not only able to provide an indication of a touch, but equally an indication of the location of a touch.

The touch sensitive means might also have a multi-function in the electronic device. For instance, if the touch sensitive means comprise a touch sensitive pad and an application is running in the electronic device which requires a text input, the signals provided by the touch sensitive means may be evaluated to recognize a handwriting on the touch sensitive pad. When an application is running in the electronic device which does not require a text input, in contrast, the signals provided by the touch sensitive means might be used as a basis for selecting a function which is to be assigned to a softkey of the electronic device. The touch sensitive means might also be used in addition for enabling a pointer functionality. That is, the touch sensitive means could be employed similar to known touch sensitive pads which allow moving a cursor on a display, etc.

Providing multi-function touch sensitive means allows keeping the surface of the electronic device and thus the electronic device itself rather small. Further, multi-function touch sensitive means allow saving components and therefore costs.

Further, the touch sensitive means may be arranged in various ways in the electronic device. For example, a portion of the surface of the electronic device might be reserved exclusively for the touch sensitive means. The extra amount of surface required to this end might not always be available, though. In an alternative embodiment, the touch sensitive means might therefore be integrated into a keypad of the electronic device.

Particular functions may then be associated to particular keys of the keypad. Touching a predetermined key of the keypad will then result in signals which cause a selection of a predetermined function for a softkey.

Basically, this means that a standard ITU-T keypad having twelve keys can provide a shortcut for up to twelve functions which could be assigned directly to one or more softkeys. The number of functions could be increased in various ways. It could be doubled, for instance, by using a “shift key” or an equivalent, which alters the function assigned to a respective regular key when touched immediately before this regular key. Also the assignment of functions to respectively two or more keys which are touched simultaneously would multiply the number of available commands.

In one embodiment of the invention, the enabled shortcuts are made visible in the softkey label.

The selection of a function may not only depend on signals from the touch sensitive means, but in addition on the current state of the electronic device. Certain signals from the touch sensitive means may thus result in the selection of another function when a first application is active in the electronic device than when a second application is active.

The signals output by the touch sensitive means might further be evaluated as to the nature of a respective touch, which allows extending the benefit of the touch sensitive means even further.

For example, only a first type of touch might be used as a basis for selecting and assigning a function to a softkey, while a second type of touch might result in an activation of a function currently assigned to a particular softkey. Different possible types of a touch include, for instance, a moving touch resulting in a fast change of signals followed by slow variations, a lasting touch resulting in a fast change of signals which then remain constant for a while, and a tap resulting in a fast change of signals and a fast change back.

Also the functions which can be assigned to a softkey by means of a touch can be selected in various ways. The functions can be for example simply the same which can be assigned in a conventional manner via a menu structure. Alternatively, the functions which can be assigned to a softkey by means of a touch could be selected functions of such a menu structure. This approach allows for instance providing a shortcut for the most popular functions, without the need to scroll a large menu structure. Further alternatively, the functions which can be assigned to a softkey by means of a touch could comprise the functions of a menu structure and some additional functions. The latter approach allows for instance keeping a menu structure clear by including only the most common functions in the menu, while providing nevertheless access to a large amount of functions by means of the touch sensitive means. Further alternatively, the functions which can be assigned to a softkey by means of a touch could supplement the functions offered by a menu structure such that some functions can only be assigned via the menu structure and other functions can only be assigned by means of the touch sensitive means. This enables an access to a particularly large amount of functions.

The invention is of particular advantage for mobile electronic devices, like mobile phones or personal digital assistants (PDA), since here, the available display is usually relatively small. The invention can equally be implemented in any other electronic device, though, which makes use of softkeys.

### BRIEF DESCRIPTION OF THE FIGURES

Other objects and features of the present invention will become apparent from the following detailed description considered in conjunction with the accompanying drawings.

FIG. 1 is a schematic block diagram of a mobile phone as a device according to an embodiment of the invention;

FIG. 2 is a flow chart illustrating an operation in the mobile phone of FIG. 1; and

FIG. 3a), 3b) and 3c) are schematic front views of the mobile phone of FIG. 1 at different stages of the operation illustrated in FIG. 2.

### DETAILED DESCRIPTION OF THE INVENTION

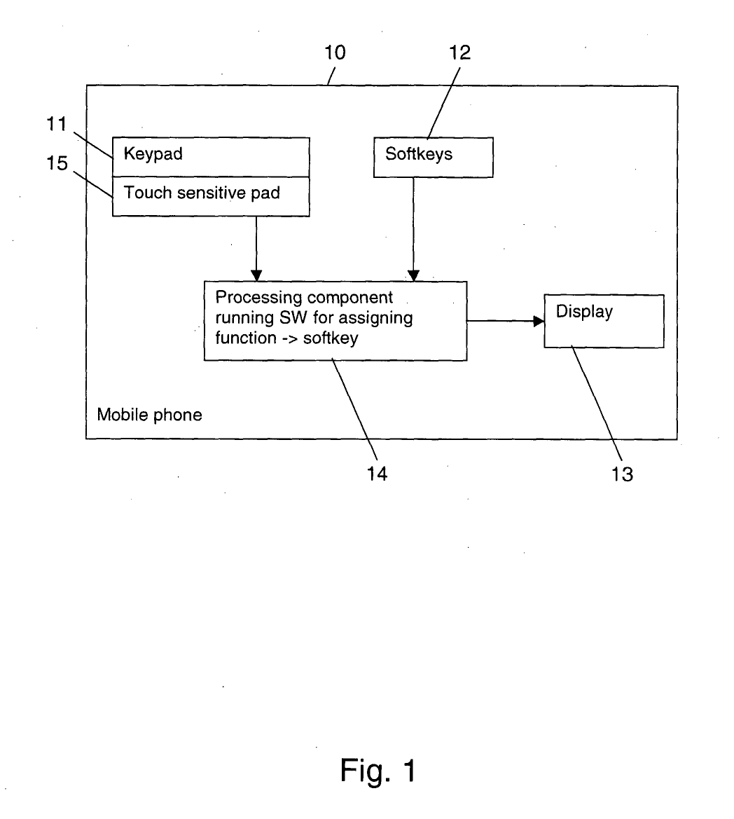

FIG. 1 is a schematic block diagram of an electronic device according to an embodiment of the invention, which enables a flexible assignment of functions to softkeys. The device is assumed by way of example to be a mobile phone, but it could equally be any other electronic device for which softkeys are provided.

The mobile phone 10 comprises a normal ITU-T keypad 11, softkeys 12, a display 13 and a processing component 14 running a software SW. In addition, a thin touch sensitive pad 15 is integrated into the keypad 11.

By way of example, the touch sensitive pad 15 is assumed to sense a touch based on varying capacitances. The touch sensitive pad 15 can be integrated into the keypad 11 in any suitable way, for instance similarly as described in U.S. Pat. No. 6,288,707 B1 for the integration of a capacitive position sensor into a keyboard.

The processing component 14 is connected to the touch sensitive pad 15, to the softkeys 12 and to the display 13.

The mobile phone 10 comprises various other components and connections as known from the art, which are not depicted in FIG. 1.

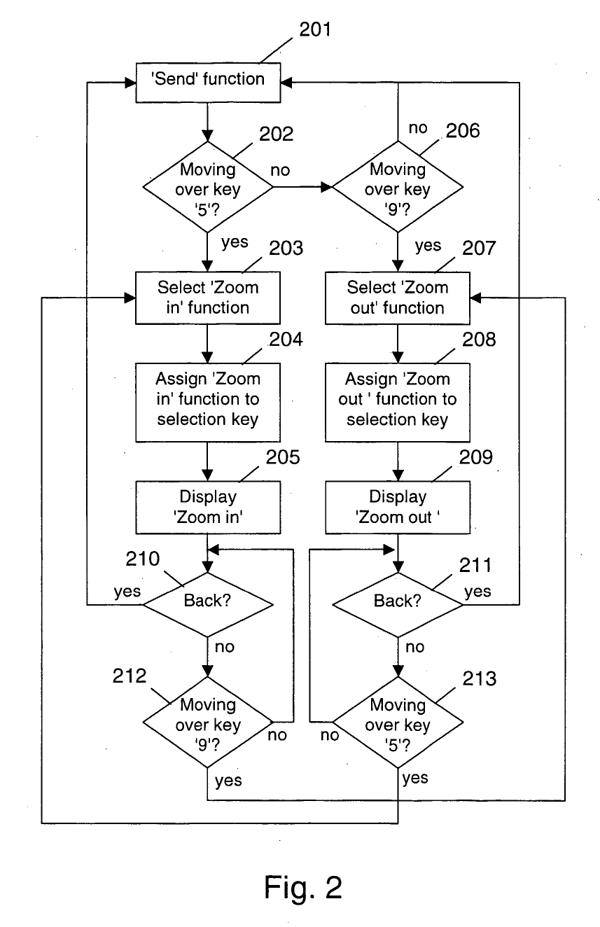

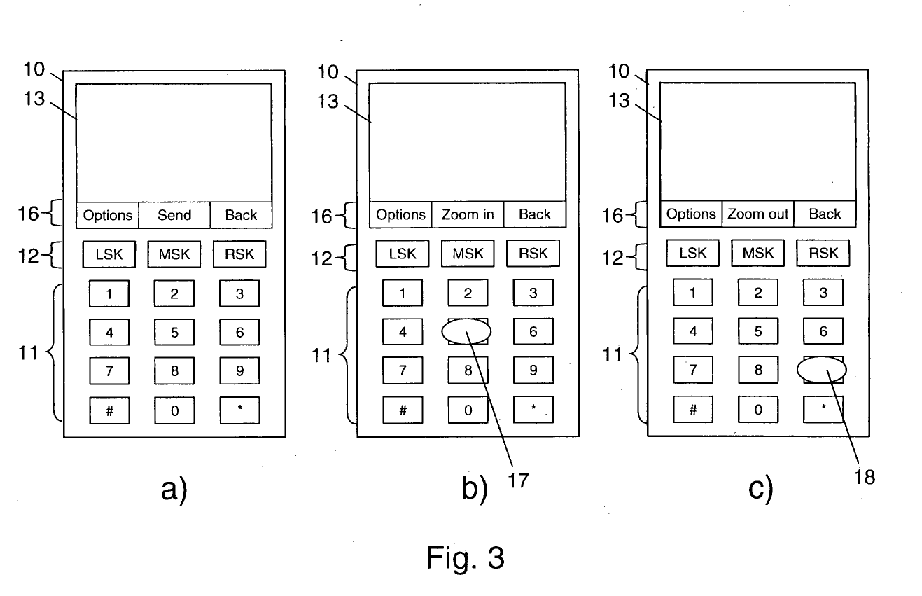

An operation of the mobile phone 10 will now be described with reference to FIGS. 2 and 3a) to c).

FIG. 2 is a flow chart illustrating the operation.

FIGS. 3a) to c) are schematic front-views of the mobile phone 10 at different stages of the operation. In each front-view, the ITU-T compliant keypad 11, including keys ‘0’ to ‘9’, ‘#’ and ‘*’ is shown. Moreover, softkeys 12 including a left softkey LSK, a right softkey RSK and a middle softkey MSK are shown in each front-view of FIGS. 3a) to c). Further, the display 13 is shown in each front-view of FIGS. 3a) to c). The touch sensitive pad 15 of the mobile phone 10 is not visible in the front-views of FIGS. 3a) to c). It covers at least the area of keys ‘5’ and ‘9’ of the keypad 11.

In the mobile phone 10, an image viewer is implemented, which is able to present and process stored images.

When the image viewer is called, default functions are assigned at first to the softkeys 12 (step 201). An options menu can be selected by pressing the left softkey LSK, the currently displayed image can be transmitted by activating the middle softkey MSK, and the image viewer can be left again by pressing the right softkey RSK. The functions ‘Options’, ‘Send’ and ‘Back’ associated to the softkeys LSK, MSK, RSK, respectively, are indicated in a softkey label section 16 of the display 13 immediately above the softkeys 12. This situation is depicted in FIG. 3a).

When the keypad 11, and thus the touch sensitive pad 15 integrated into the keypad 11, is touched, the touch sensitive pad 15 transmits signals to the processing component 14. The value of the transmitted signals depends on the position at which the touch sensitive pad 15 is touched. Different signal values are transmitted, for example, when a user moves a finger over key ‘5’ compared to when a user moves a finger over key ‘9’. The processing component 14 monitors continuously whether it receives signals from the touch sensitive pad 15. The processing component 14 is able to differentiate between different signal values. In addition, the processing component is 14 able to differentiate between signals which result from a tap onto a key and signals which result from lasting or moving touch of a key.

If the processing component 14 detects signals which indicate a moving of a finger, etc., over key ‘5’ (step 202), the processing component 14 selects a function ‘Zoom in’ (step 203) and assigns this function to the middle softkey MSK (step 204). In addition, the processing component 14 causes an exchange of the indication ‘Send’ in the softkey label section 16 to an indication ‘Zoom in’, such that the label corresponds to the new function of the middle softkey MSK (step 205).

This situation is depicted in FIG. 3b), in which touched key ‘5’ is highlighted by a white oval 17 and in which the indication in the softkey label section 16 of the display 13 has been changed.

If the processing component 14 does not detect signals which indicate a moving of a finger, etc., over key ‘5’ (step 202), but signals which indicate a moving over key ‘9’ (step 206), the processing component 14 selects a function ‘Zoom out’ (step 207) and assigns this function to the middle softkey MSK (step 208). In addition, the processing component 14 causes an exchange of the indication ‘Send’ in the softkey label section 16 to an indication ‘Zoom out’, such that the label corresponds to the new function of the middle softkey MSK (209).

This situation is depicted in FIG. 3c), in which touched key ‘9’ is highlighted by a white oval 18 and in which the indication in the softkey label section 16 of the display 13 has been changed.

If the processing component 14 does not detect signals which indicate a moving over key ‘9’ either (step 206), the default function ‘Send’ assigned to the middle softkey MSK is maintained.

Once a new function has been assigned to the middle softkey MSK, the processing component 14 monitors a user input via the right softkey RSK, to which still a function ‘Back’ is assigned (steps 210, 211). If this right softkey 32 is pressed, the default function ‘Send’ is assigned again to the middle softkey MSK and the softkey label section 16 of the display 13 is updated accordingly (step 201). This situation is depicted again in FIG. 3a).

As long as none of the softkeys 12 is pressed (steps 210, 211), the processing component 14 monitors further signals from the touch sensitive pad 15.

If the function currently assigned to the middle softkey MSK is ‘Zoom in’, and the processing component 14 detects that key ‘9’ is touched (step 212), the operation is continued with step 207. This situation is depicted again in FIG. 3c).

If the function currently assigned to the middle softkey MSK is ‘Zoom out, and the processing component 14 detects that key ‘5’ is touched (step 213), the operation is continued with step 203. This situation is depicted again in FIG. 3b).

The functions which can be assigned by the processing component 14 to the middle softkey MSK might also be reached via the function ‘Options’ offered by the left softkey LSK. Some functions, however, might also be reached exclusively by using the touch sensitive pad 15.

For instance, the functions of the middle softkey MSK which can be reached via the options offered by the ‘Options’ function of the left softkey LSK might comprise for an image viewer the functions ‘rotate’, ‘zoom in’ and ‘zoom out’, while the functions of the middle softkey MSK which can be reached via the touch sensitive pad 15 might comprise the functions ‘rotate left’, ‘rotate right’, ‘zoom in’, ‘zoom out’, ‘move left’, ‘move right’, ‘move up’, ‘move down’, ‘full screen’ and ‘normal view’.

Once a function has been assigned to the middle softkey MSK, this function can be activated by pressing the middle softkey MSK. If the middle softkey MSK is pressed, a dedicated signal is provided to the processing component 14, which activates thereupon the function currently assigned to the middle softkey MSK. Alternatively, the function can be activated by tapping onto any of the fixed keys 11 and thereby onto the touch sensing pad 15. The processing component 14 realizes in this case that signals received from the touch sensing pad 15 result from a tapping, not from a lasting touch and activates the function currently assigned to the middle softkey MSK.

Tapping the standard ITU-T keypad is a convenient alternative to first changing a function in the soft key and then pressing the middle softkey. Tapping the softkey would not even require the middle softkey, if the assigned function is shown at some place on the display or indicate by other means.

It is to be noted that the described embodiment constitutes only one of a variety of possible embodiments of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. Method of controlling an assignment of functions to at least one softkey (12) of an electronic device (10), wherein at least two different functions are available for an assignment to said at least one softkey (12), and wherein said electronic device (10) further comprises touch sensitive means (15), which touch sensitive means (15) are adapted to detect a touch of at least one predetermined part of said electronic device (10) and to output signals indicating a detected touch, said method comprising:
selecting (203, 207) a function based on signals from said touch sensitive means (15); and
assigning (204, 208) said selected function to said at least one softkey (12).

2. Method according to claim 1, further comprising indicating (205, 209) to a user which function is currently assigned to said at least one softkey (12).

3. Method according to claim 1 or 2, wherein said electronic device (10) comprises a keypad (11), wherein said touch sensitive means (15) are integrated into said keypad (11), and wherein touching a predetermined key of said keypad (11) results in signals which cause a selection (203, 207) of a predetermined function for said at least one softkey (12).

4. Method according to one of the preceding claims, wherein a function is selected (203, 207) based on said signals from said touch sensitive means (15) and on a current state of said electronic device (10).

5. Method according to one of the preceding claims, further comprising determining a type of a touch of said touch sensitive means (15) based on said signals, a first type of touch resulting in said selection (203, 207) and said assignment (204, 208) of a function, and a second type of touch resulting in an activation of a function currently assigned to said at least one softkey (12).

6. Method according to one of the preceding claims, comprising recognizing a handwriting performed on said touch sensitive means (15) based on signals output by said touch sensitive means (15) when an application requiring a text input is running in said electronic device (10), and selecting and assigning a function to said at least one softkey (12) based on signals output by said touch sensitive means (15) when an application not requiring any text input is running in said electronic device (10).

7. Electronic device (10) comprising:
at least one softkey (12), wherein at least two different functions are available for being assigned to said at least one softkey (12);
touch sensitive means (15) adapted to detect a touch of at least one predetermined part of said electronic device (10) and to output signals indicating a detected touch; and
a processing component (14) adapted to select a function based on signals output by said touch sensitive means (15) and to assign a selected function to said at least one softkey (12).

8. Electronic device (10) according to claim 7, further comprising a display (13), said processing component (14) being adapted to cause an indication of a function currently assigned to said at least one softkey (12) on said display (13).

9. Electronic device (10) according to claim 7 or 8, further comprising a keypad (11), wherein said touch sensitive means (15) are integrated into said keypad (11), and wherein said processing component (14) is adapted to select a predetermined function for said at least one softkey (12), if signals output by said touch sensitive means (15) indicate a touching of a predetermined key of said keypad (11).

10. Electronic device (10) according to one of claims 7 to 9, wherein said processing component (14) is adapted to select a function based on signals from said touch sensitive means (15) and on a current state of said electronic device (10).

11. Electronic device (10) according to one of claims 7 to 10, wherein said processing component (14) is further adapted to determine a type of a touch of said touch sensitive means (15) based on signals output by said touch sensitive means (15), said processing component (14) being adapted to select and assign a function to said at least one softkey (12) in case of a determined first type of touch, and to activate a function currently assigned to said at least one softkey (12) in case of a determined second type of touch.

12. Electronic device (10) according to one of claims 7 to 11, wherein said processing component (14) is adapted to recognize a handwriting performed on said touch sensitive means (15) based on signals output by said touch sensitive means (15) when an application requiring a text input is running in said electronic device (10), and wherein said processing component (14) is adapted to select and assign a function for said at least one softkey (12) based on signals output by said touch sensitive means (15) when an application not requiring any text input is running in said electronic device (10).

13. Electronic device (10) according to one of claims 7 to 12, wherein said touch sensitive means (15) comprises a touch sensitive pad.

14. Electronic device (10) according to one of claims 7 to 13, wherein said electronic device (10) is a mobile electronic device.

15. A software program product in which a software code for controlling an assignment of functions to at least one softkey (12) of an electronic device (10) is stored, wherein at least two different functions are available for an assignment to said at least one softkey (12), and wherein said electronic device (10) further comprises touch sensitive means (15), which touch sensitive means (15) are adapted to detect a touch of at least one predetermined part of said electronic device (10) and to output signals indicating a detected touch, said software code realizing the following steps when running in a processing component (14) of an electronic device (10):
selecting (203, 207) a function based on signals received from said touch sensitive means (15); and
assigning (204, 208) said selected function to said at least one softkey (12).

16. A software code for controlling an assignment of functions to at least one softkey (12) of an electronic device (10), wherein at least two different functions are available for an assignment to said at least one softkey (12), and wherein said electronic device (10) further comprises touch sensitive means (15), which touch sensitive means (15) are adapted to detect a touch of at least one predetermined part of said electronic device (10) and to output signals indicating a detected touch, said software code realizing the following steps when running in a processing component (14) of an electronic device (10):
selecting (203, 207) a function based on signals received from said touch sensitive means (15); and
assigning (204, 208) said selected function to said at least one softkey (12).
